(19) United States
(12) Patent Application Publication
(10) Pub. No.: US 2005/0219637 A1
(43) Pub. Date: Oct. 6, 2005

(54) Digital camera and image data

(75) Inventor: Mikio Sasagawa, Saitama (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/033,737

(22) Filed: Jan. 13, 2005

(30) Foreign Application Priority Data
Jan. 14, 2004 (JP) 2004-006942

(51) Int. Cl. H04N 1/21; H04N 1/23

(52) U.S. Cl. 358/302; 358/471

(57) ABSTRACT

A digital still camera has a shutter release button for photographing an image upon being depressed. An image file of image data of the image being obtained is written to a memory card. There is a setting menu button operable externally. A read/write controller outputs security information for access locking in addition to the memory card if the shutter release button is depressed in depressing the setting menu button, to write the security information to the memory card. A controller checks whether the security information is added to the image data, and if the security information is not found added, authorizes access to the image data. If the security information is found added, the image data is locked by determining the image data as a locked image file of image data, for protection of the locked image data from an unauthorized access.

### BACKGROUND OF THE INVENTION

1. Field of the Invention

The present invention relates to a digital camera and image data processing method. More particularly, the present invention relates to a digital camera and image data processing method in which image data can be easily protected from unauthorized access.

2. Description Related to the Prior Art

A digital still camera includes a taking lens for focusing an image of an object. A CCD image sensor or image pickup device in the digital still camera converts the focused image into an electronic form of an image. A memory card as storage medium is set in the digital still camera, which writes digital data of the image from the CCD. A rear of a camera body of the digital still camera has an LCD display panel, in which an image of image data read from the memory card is displayed easily. Furthermore, it is possible to output the image data from the memory card to a personal computer or other external devices, to edit an album or a sequence of images. EP-B 1 039 749 (corresponding to JP-A 2000-278634) and WO-A 01/15440 disclose examples of digital still camera.

Recently available types of the memory card have had a considerably large capacity so as to store the image data of a very great amount. It is possible for plural users to use the memory card commonly. However, the access to the data in the memory card is free between such plural users. A problem arises in failure of protecting security of a single user. If he or she wishes to keep the image confidential, a third party may view the image without his or her authorization. Furthermore, the image data may be deleted from the memory card without his or her intention.

JP-A 2002-218389 discloses a type of the digital still camera in which a password is input by the user, and the image data is written to the memory card together with the password. After the storing of the image, the digital still camera authorizes access to the image data according to coincidence of the password by verifying the password input subsequently by the user. Only particular ones of the image data can be authorized for access according to the password. This can ensure the security because of protection of a third party from viewing the image or from deleting the image data from the memory card, without authorization of the user.

However, the digital still camera according to JP-A 2002-218389 requires the operation of inputting the password when the user uses the digital still camera. This causes a complexity in handling, and inconsistent to easy operability of the digital still camera.

### SUMMARY OF THE INVENTION

In view of the foregoing problems, an object of the present invention is to provide a digital camera and image data processing method in which image data can be easily protected from unauthorized access.

In order to achieve the above and other objects and advantages of this invention, a digital camera is provided, including plural operation units operable externally for determining a setting of items, and which writes image data obtained by photographing to a storage medium. In the digital camera, a read/write controller controls reading from and writing to the storage medium with the image data. A controller is responsive if the shutter release button is depressed for photographing in shifting a first operation unit predetermined among the plural operation units, for causing the read/write controller to write security information in addition to the image data, the security information being associated with the first operation unit for access locking. In reading the image data from the storage medium, the controller controls the read/write controller to inhibit access to locked image data constituted by addition of the security information to the image data.

Furthermore, a display panel displays a menu pattern constituted by the items to be set by the plural operation units.

The plural operation units include a second operation unit, being different from the first operation unit, and adapted for unlocking. If the first operation unit is shifted in shifting the second operation unit, the controller interrupts the access locking, and authorizes access to the locked image data irrespective of addition of the security information.

The first operation unit is at least one selected from the plural operation units by external operation.

The menu pattern is provided with indicated information including specific reference information of the plural operation units, disposed in a position for keeping respectively the plural operation units discernible. A movable pointing pattern points selected information selected from the specific reference information, to determine the first operation unit selectively among the plural operation units.

If the first operation unit is shifted in shifting the second operation unit, the controller locks the image data being without addition of the security information, and protects the image data from access.

If the first operation unit is shifted for a second time in shifting the second operation unit, the controller locks the locked image data again in addition of the security information for access locking.

The second operation unit comprises a mode changer for setting a selected one of plural indication mode so as to indicate the image according thereto on the display panel according thereto.

In one preferred embodiment, the second operation unit comprises a camera powering switch.

Furthermore, a taking lens focuses object light. A lens barrier is movable between closed and open positions in front of the taking lens, for covering the taking lens when in the closed position, and for causing the taking lens to emerge when in the open position. The camera powering switch turns on upon movement of the lens barrier to the open position.

At least a confidential image folder and a regular image folder are used in the controller, the confidential image folder is assigned to the locked image data in addition of the security information, the regular image folder is assigned to the image data being without addition of the security information.

The confidential image folder is defined in association with the first operation unit.

The display panel further displays an image. The plural operation units include a setting menu operation unit for shifting to change over the display panel displaying the image, and for causing the display panel to display a menu pattern.

The plural operation units include a cancellation operation unit for changing over the display panel displaying the menu pattern, to display the image thereon.

The first operation unit is at least one of the setting menu operation unit and the cancellation operation unit.

The image data is inhibited from being transferred, copied or deleted by protection from the access.

According to one aspect of the invention, an image data processing method of image data processing in a digital camera is provided, the digital camera being operable by setting a selected one of a photographing mode and a playback mode, the photographing mode being adapted to photographing an image upon depressing a shutter release button to write image data of the image to a storage medium, the playback mode being adapted to displaying an image on a display panel by reading image data from the storage medium. In the image data processing method, while the photographing mode is set, security information is output for access locking in addition to the image data if the shutter release button is depressed in shifting a first operation unit operable externally, to write the security information to the storage medium. While the playback mode is set, it is checked whether the security information is added to the image data. If the security information is not found added, access to the image data is authorized, wherein if the security information is found added, the image data is locked by determining the image data as locked image data, for protection of the locked image data from an unauthorized access.

### BRIEF DESCRIPTION OF THE DRAWINGS

The above objects and advantages of the present invention will become more apparent from the following detailed description when read in connection with the accompanying drawings, in which:

FIG. 1 is a perspective illustrating a front side of a digital still camera;

FIG. 2 is a perspective illustrating a rear side of the digital still camera;

FIG. 3 is a rear elevation illustrating a setting menu pattern for selectively determining a first operation unit;

FIG. 4 is a block diagram schematically illustrating circuitry of the digital still camera;

FIG. 5 is a diagram schematically illustrating image files;

FIG. 6 is a diagram schematically illustrating folders for images files;

FIG. 7 is a flow chart illustrating a process of image pickup in the digital still camera; and

FIG. 8 is a flow chart illustrating a process of playback of images in the digital still camera.

### DETAILED DESCRIPTION OF THE PREFERRED EMBODIMENT(S) OF THE PRESENT INVENTION

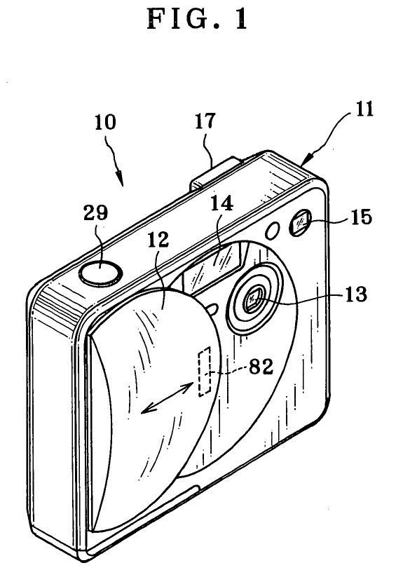

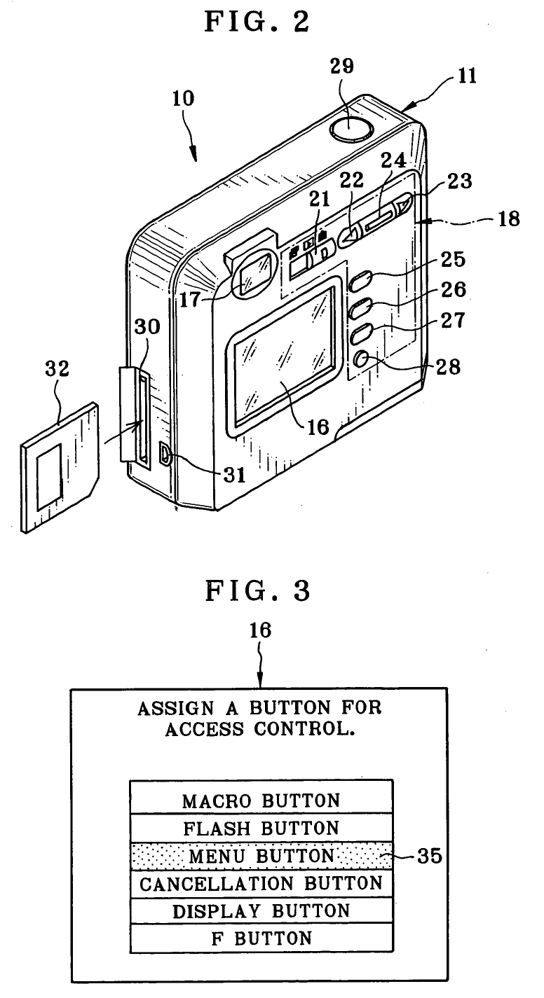

In FIG. 1, a digital still camera 10 of the invention is illustrated. In FIG. 2, the digital still camera 10 is viewed in the rear in contrast to FIG. 1. A camera body 11 of the digital still camera 10 has a front panel, in which a camera powering lens barrier 12 is incorporated and slidable in the arrow direction as indicated. There are a taking lens 13 and an electronic flash device 14, which are caused to appear in the front upon sliding of the lens barrier 12 to the open position of FIG. 1. The lens barrier 12 is provided with a camera powering switch 82 as a second operation unit, and when slid and set in the open position, turns on the power source to stand by for image pickup, and when slid and set in the closed position, turns off the power source. There is a viewfinder objective window 15 positioned in the front of the camera body 11 to constitute an optical viewfinder.

The rear of the camera body 11 has an LCD display panel 16, a viewfinder eyepiece window 17, and an operation panel 18. The viewfinder eyepiece window 17 is an element included in an optical viewfinder. The operation panel 18 is a group of plural operation units, and operable to a user. On the LCD panel 16, various patterns are indicated, including images after being photographed, and menu patterns for inputting settings. Also, the LCD panel 16 can be used as an electronic viewfinder by displaying a live image of an object in a real time manner.

The operation panel 18 has various elements, which are a mode changer switch 21, a macro button 22 or close-up button, a flash setting button 23, a zoom button 24, a setting menu button 25, a cancellation button 26, a display button 27, a photo mode (F) button 28, and the camera powering lens barrier 12 described above. The mode changer switch 21 or key as a second operation unit is manually slid by a user, and set in a selected one of positions of a still image pickup mode, a motion picture pickup mode, and a playback mode. The macro button 22 or key as operation unit is manually depressed for turning on or off of macroscopic photographing. The flash setting button 23 or key as operation unit is manually depressed for determining a selected one of an automatic flash emitting status, a forcibly flash emitting status, and a flash disabled status.

The zoom button 24 or key as operation unit is operated up or down by a user in order to move a zoom lens constituting the taking lens 13 between a wide-angle end and a telephoto end so as to change a magnification. The setting menu button 25 or key as a first operation unit is depressed manually to indicate a setting menu pattern in the LCD panel 16, and also to confirm a selected one of parameters or items indicated in the menu pattern. The cancellation button 26 or key as a first operation unit is depressed for interrupting operation of setting the various items in the setting menu pattern, or for returning to one preceding pattern or image. The display button 27 or key as operation unit is depressed by a user manually to switch on and off the LCD panel 16. The photo mode button 28 or key as operation unit is depressible manually to change various characteristics or functions including the number of pixels of an image, ISO sensitivity and the like.

While the LCD panel 16 displays the menu pattern, any of the macro button 22, the flash setting button 23 and the zoom button 24 can be used as a cursor moving button for moving a pointing cursor in the menu pattern. Also, displayed images in the playback mode can be changed over sequentially after one another in one of forward and backward directions.

A shutter release button 29 protrudes from an upper face of the camera body 11. The shutter release button 29 has a structure for two-step depression. When a user observes and frames an object by use of the LCD panel 16 or optical viewfinder, he or she depresses the shutter release button 29 in the half step. Exposure and focusing of the taking lens 13 are adjusted. When the user fully depresses the shutter release button 29, an exposure is taken. Also, a lateral surface of the camera body 11 has a memory card slot 30 and an output terminal 31. A memory card 32 as a storage medium is inserted in the memory card slot 30 removably, and stores image data written thereto. The output terminal 31 is a USB (Universal Serial Bus) terminal, and used for outputting the image data stored in the memory card 32 to an external device, for example a personal computer.

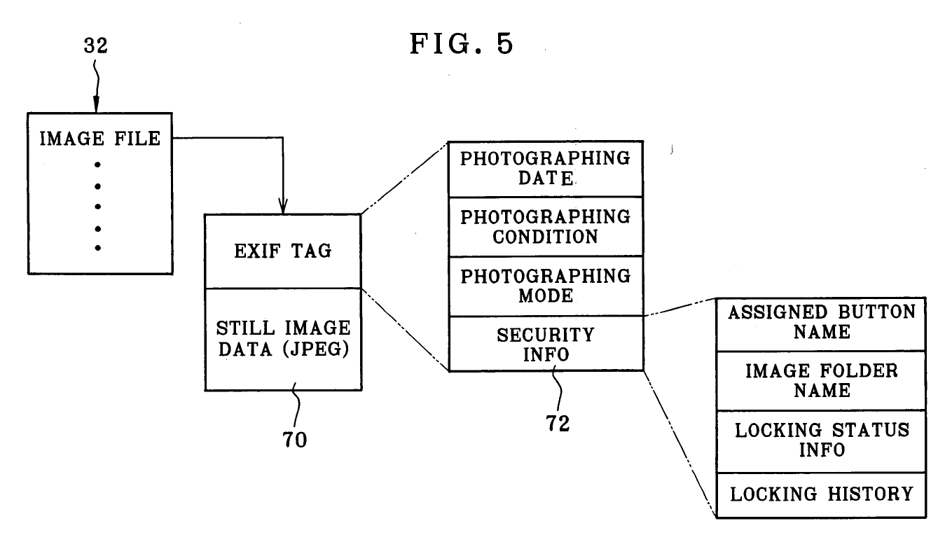

The digital still camera 10 is constructed for keeping security in preventing a third party from view, deletion, reproduction or transfer of image of the image data stored in the memory card 32. The setting menu button 25 as first operation unit among elements included in the operation panel 18 is kept depressed when the shutter release button 29 is fully depressed to pick up an image. Security information or security flag 72 (See FIG. 5) predetermined according to the setting menu button 25 is added to image data obtained by the image pickup, and is written to the memory card 32. The image data in addition of the security information 72 is kept locked and prevented from being read, deleted, reproduced or transferred at the output terminal 31. Access or reading of this is inhibited totally.

The security recording is to add the security information 72 to image data when the shutter release button 29 is fully depressed during a depression of the first operation unit in the operation panel 18. The first operation unit is assigned by a user among the various operation units included in the operation panel 18.

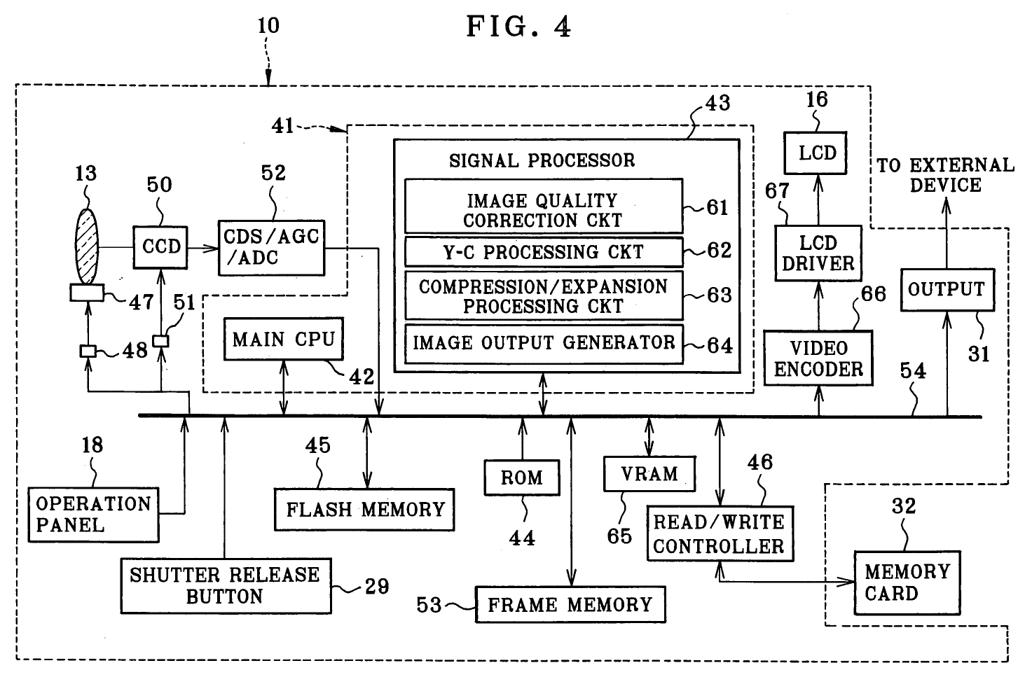

In FIG. 3, the use of a pointing cursor 35 as pointing pattern is illustrated. The zoom button 24 is shifted up or down while a menu pattern for designating an assigned button is displayed. The pointing cursor 35 is set by shifting the zoom button 24 at a desired one of button portions, to assign a button of the desired button portion as first operation unit. Note that it is possible to assign one button or plural buttons as first operation unit.

To interrupt the locked state of the image data with the security information 72 added thereto, the second operation unit, for example the mode changer switch 21, is depressed at the same time as the first operation unit. This invalidates the security information 72 of the image data in association with the first operation unit. The access to the image data is authorized by unlocking. Also, when the second operation unit or the mode changer switch 21 is depressed for a second time and simultaneously with the first operation unit, the security information 72 is validated again for the image data. The access to the image data is inhibited, to lock the reading.

In FIG. 4, relevant circuitry in the digital still camera 10 is illustrated schematically. A digital signal processor (DSP) 41 includes a main CPU 42 as controller, and a signal processor 43. The main CPU 42 receives command signal generated from the operation panel 18, and controls elements in the digital still camera 10 according to the signal. ROM 44 stores information including a control program for execution in the main CPU 42, control data of various kinds, and the like. A non-volatile flash memory 45 is a memory of which data are rewritable. Parameter information of various items are written to the flash memory 45, including name information or reference information of a button name of a button assigned as first operation unit for security.

The memory card 32 is set on the camera body 11 removably, and used for storing the image data obtained by photographing an object. A read/write controller 46 or media controller accesses the memory card 32 and controls writing and reading of image files. In FIG. 5, the image files are shown, each of which is constituted by image data 70 and EXIF TAG, the image data 70 being still image data obtained by photography and having a compressed state in the JPEG format (Joint Photographic Experts Group). The main CPU 42 controls the read/write controller 46 to write an image file with EXIF TAG added to the image data 70 to the memory card 32.

Also, the main CPU 42 controls the read/write controller 46 to write the security information 72 to the memory card 32 at EXIF TAG of an image file in addition to the image data when the first operation unit is depressed during the image pickup for security. Specifically, the security information 72 is constituted by, for example, the button name information, managing folder name information, locked state information, and locked history information, the locked state information being one of states of inhibiting or authorizing the access of the image files.

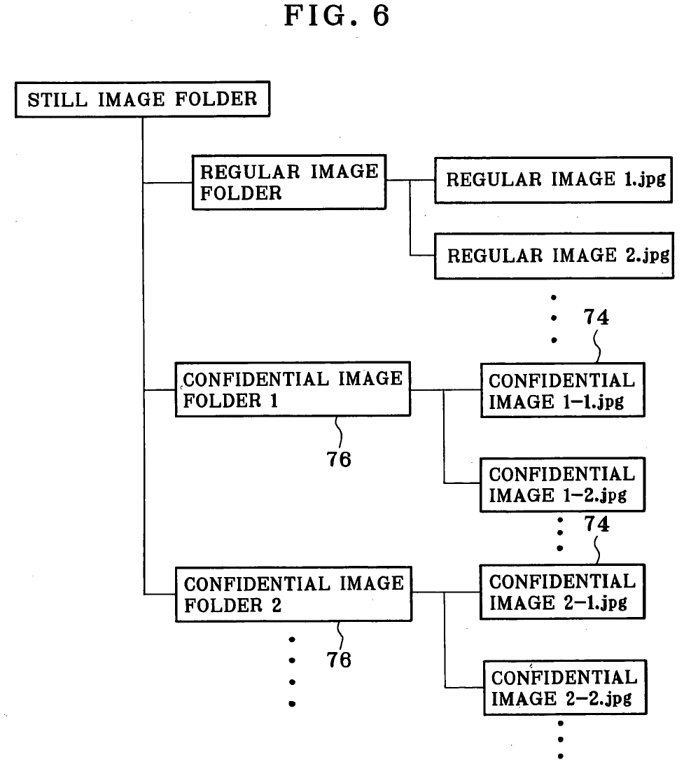

A locked image file 74 of locked image data has the security information 72 added thereto in association with the first operation unit. The locked image file 74 is managed in a folder particularly associated with the first operation unit. In FIG. 6, there are a number of still image folders for managing numerous still image files. The still image folders include regular image folder and a plurality of confidential image folders 76. The regular image folder is used to manage regular image files without the security information 72. The confidential image folders 76 are used to manage confidential image files with the security information 72 added thereto. A plurality of the confidential image folders 76 are defined, each of which is associated with one of the first operation units.

It is noted that the managing of folders in images of the motion picture set by the mode changer switch 21 is similar to that in the still images.

While the read/write controller 46 is controlled to read the image data 70 from the memory card 32, the main CPU 42 does not read image data of the locked image file 74 with the security information 72 added thereto. In the playback mode, playback or reading of the locked image data with the security information 72 is inhibited, so as to prevent a third party from viewing the image according to the image data 70. Also, the main CPU 42 controls the read/write controller 46 to prevent deletion, copying or transfer of the image data with the security information 72 added thereto.

In FIG. 4, a lens driving mechanism 47 having a motor drives the taking lens 13. The taking lens 13 is caused to move back or forth in the direction of the optical axis. A lens driving circuit 48 receives a command signal from the main CPU 42, controls the lens driving mechanism 47, and changes and adjusts a magnification of image pickup and a focal point. A CCD image sensor 50 is disposed behind the taking lens 13 as a image pickup device. The CCD 50 is well-known in the art, has a photoelectrically detecting surface on which a great number of photoreceptor elements are arranged in a matrix form. Object light passed through the taking lens is focused on the detecting surface, which photoelectrically converts the object light into an electric signal.

A CCD driver 51 supplies the CCD 50 with vertical transfer clock and horizontal transfer clock. In synchronism with these, an analog signal processing circuit 52 receives a image pickup signal in a serial form from the CCD 50, the image pickup signal being associated with each one of lines and constituted by electric charge stored for respective pixels. The analog signal processing circuit 52 is constituted by a correlated double sampling (CDS) circuit, automatic gain control (AGC) circuit, AD converter, and the like. Noise is eliminated from the image pickup signal as an analog signal. Also, the gain is adjusted. Then the image pickup signal in the analog form is converted into a digital signal, to produce the image data.

When the image pickup mode is selected, the CCD 50 starts picking up a live image. When the shutter release button 29 is depressed fully for the main image pickup operation, a photographed image is obtained and retrieved by interrupting the image pickup of the live image. After the main operation of the image pickup, image pickup of a live image starts again. A frame memory 53 is connected with the digital signal processor 41, by which the live image and photographed image are written to the frame memory 53.

The frame memory 53 is a work memory for use in signal processing of various items in the signal processor 43 for image data. There is a data bus 54 where the frame memory 53 is connected with the digital signal processor 41. An example of the frame memory 53 is SDRAM. An image written to the frame memory 53 is subjected to image processing of various items by the digital signal processor 41.

The signal processor 43 includes an image quality correction circuit 61, a Y-C processing circuit 62, a compression/expansion processing circuit 63, and an image output generator 64. The image quality correction circuit 61 subjects image data to correction of various items including gamma correction, sharpness correction, contrast correction and the like. The Y-C processing circuit 62 converts the CCD-RAW data into Y-C data which is a combination of brightness data and color difference data. The compression/expansion processing circuit 63 subjects the Y-C data to processing of compression and/or expansion. Before writing of the image data to the memory card 32, the compression/expansion processing circuit 63 compresses the image data. In the playback mode, the compression/expansion processing circuit 63 subjects the image data from the memory card 32 to expansion.

The image output generator 64 produces and outputs signals of output images to cause the LCD panel 16 to display an image in any one of a still image pickup mode, a motion picture pickup mode, and a playback mode. A VRAM 65 is a memory, to which output image data from the image output generator 64 is written. A video encoder 66 reads the output image data from the VRAM 65, and converts the image data of the digital signal into a composite signal or video signal in an analog form, which is sent to an LCD driver 67. The LCD driver 67 drives the LCD panel 16 to display an image according to the video signal. Also, the operation panel 18 and the output terminal 31 are connected with the main CPU 42 by means of the data bus 54.

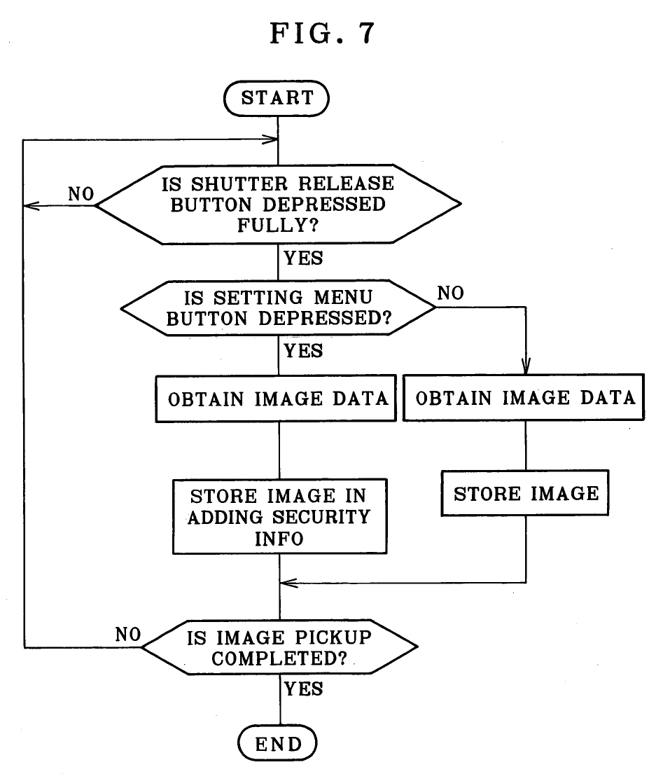

The operation of the digital still camera 10 constructed above is described. At first, a process of image pickup is described by referring to the flow chart of FIG. 7. Let the mode changer switch 21 be positioned to set the still image pickup mode. Let the setting menu button 25 be assigned as first operation unit. The still image pickup mode being designated by the mode changer switch 21, the digital still camera 10 stands ready for image pickup.

The user depresses the shutter release button 29 halfway, to adjust the exposure, adjust the focusing and the like for readiness for photography. If the shutter release button 29 is not depressed fully, then the ready state standing by for image pickup is maintained. When the shutter release button 29 is depressed fully, the main CPU 42 obtains a command signal of image pickup, controls the CCD 50 or the like to retrieve image data. Also, the main CPU 42 checks whether the setting menu button 25 as first operation unit is depressed or not. If it is determined that the setting menu button 25 is depressed, then the main CPU 42 controls the read/write controller 46, adds the security information or security flag 72 to EXIF TAG in association with the setting menu button 25, to record the locked image file 74 to the memory card 32 in combination with the image data and EXIF TAG, for example confidential image 1-1.jpg. The security information 72 is a combination of a button name, a folder name and the like, the button name being the setting menu button 25 or the like assigned to the first operation unit, the folder name being Folder 1 of the confidential image folders 76 associated with the setting menu button 25. The confidential image 1-1.jpg is managed with Folder 1 of the confidential image folders 76.

If it is determined that the setting menu button 25 is not depressed, then no information of the security information 72 is added to EXIF TAG. A regular image file 1.jpg as a combination of image data and EXIF TAG is written to the memory card 32. The regular image file 1.jpg is managed by use of a regular image folder.

After this, the camera mode is changed over by operating the mode changer switch 21, so as to terminate the image pickup process. In a manner similar to this, the image pickup process is terminated when the power source is turned off. If the camera mode remains set as a still image pickup mode, the operation returns to the initial process. The image pickup process is repeated.

It is conceivable that plural buttons are assigned as first operation unit, information of those being stored in the flash memory 45. For example, a user depresses the shutter release button 29 at the same time as depressing the cancellation button 26 which is different from the setting menu button 25. Then the main CPU 42 checks whether the cancellation button 26 has been registered in the flash memory 45 as first operation unit. If it is determined that the cancellation button 26 is not registered in the flash memory 45 as first operation unit, then the main CPU 42 controls the read/write controller 46 to write the image data to the memory card 32 as a regular image file without adding the security information 72 to EXIF TAG.

If it is determined that the cancellation button 26 has been registered as first operation unit in the flash memory 45, then the main CPU 42 controlling the memory card 32 adds the security information 72 to EXIF TAG in association with the cancellation button 26, to write the locked image file 74 to the memory card 32 in combination with the image data and EXIF TAG, for example confidential image 2-1.jpg. The security information 72 is a combination of a button name, a folder name and the like, the button name being the cancellation button 26 or the like assigned to the first operation unit, the folder name being Folder 2 of the confidential image folders 76 associated with the cancellation button 26. The confidential image 2-1.jpg is managed with Folder 2 of the confidential image folders 76. Accordingly, the confidential image folders 76 are used for managing image data for any of all the assigned first operation units. Image files can be managed easily.

Consequently, the security information 72 is added to image data only by additionally operating the first operation unit. The security information 72 is kept stored in the memory card 32 with the image data, and inhibits access or reading of the image data. Image data can be prevented from being deleted, reproduced, copied or externally transferred by a third party without authorization of the user. There is no inputting of a password or other key information which might take considerable time during operation. Easy operability of the image pickup can be maintained even if a number of consecutive images are desired for pickup.

It is noted that the image pickup operation in the motion picture pickup process selected by the mode changer switch 21 is similar to that in the still image pickup process. No further description is made.

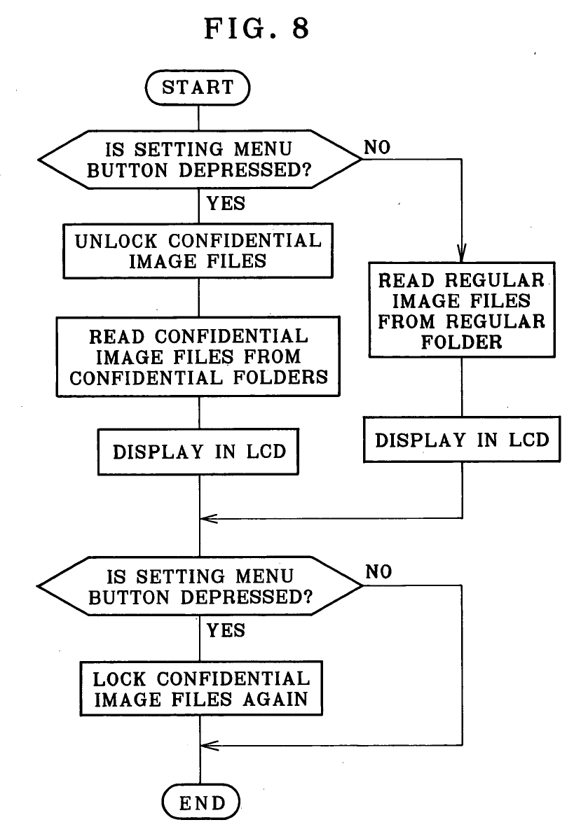

A flow chart of FIG. 8 is referred to now, to describe a process of playback. The setting menu button 25 is again assigned as first operation unit. The mode changer switch 21 is set by sliding for changing over to the playback mode. Then the main CPU 42 checks whether the setting menu button 25 is depressed or not.

If it is determined that the setting menu button 25 is not depressed, the main CPU 42 controls the read/write controller 46 to read only regular image files from the memory card 32 without the security information 72, the regular image files being managed by use of the regular image folder. Reading of the locked image files 74 managed by use of the confidential image folders 76 is suppressed, the locked image files 74 being image files in addition of the security information 72.

After this, an image of the regular image file is displayed on the LCD panel 16. The macro button 22 and the flash setting button 23 are depressed to read and display a number of images of the image data 70 in the image files managed in the regular image folder. This is in a forward or backward sequence as intended by the user. It is also possible to display a whole group of the image data 70 of the regular image files in the regular image folder in the LCD panel 16 in a listed manner or thumbnail manner. This makes it possible to delete or copy the regular image files in the regular image folder as desired. Also, image files can be transferred externally through the output terminal 31 to an external device, for example a personal computer.

If it is determined that the setting menu button 25 is depressed, then the main CPU 42 operates to cause the read/write controller 46 to read the confidential image folders 76 from the memory card 32 in association with the setting menu button 25, for example the locked image files 74 managed by means of Folder 1 of the confidential image folders 76. There occurs no reading of the locked image files 74 managed by means of the confidential image folders 76 not associated with the setting menu button 25, for example Folder 2 of the confidential image folders 76.

After this, an image from the locked image file 74 is displayed on the LCD panel 16. The macro button 22 and the flash setting button 23 are depressed to read and display a number of images of the image data in the locked image files 74 managed in Folder 1 of the confidential image folders 76. This is in a forward or backward sequence as intended by the user. It is also possible to display a whole group of image data of the locked image files 74 in Folder 1 of the confidential image folders 76 in the LCD panel 16 in a listed manner or thumbnail manner. This makes it possible to delete or copy the locked image files 74 in Folder 1 of the confidential image folders 76. Also, the locked image files 74 can be transferred externally through the output terminal 31 to an external device, for example a personal computer.

If the mode changer switch 21 as second operation unit is changed over from the playback mode to one of the remaining modes, then the main CPU 42 checks whether the setting menu button 25 as first operation unit is depressed or not. If it is determined that the setting menu button 25 is not depressed, then information of history of locking of the security information 72 is renewed in a state of unlocking the locked image files 74 in Folder 1 of the confidential image folders 76. The playback is terminated.

In contrast, if it is determined that the setting menu button 25 is depressed, then the locked image files 74 in Folder 1 of the confidential image folders 76 are locked again. Information of history of locking of the security information 72 is renewed. The playback is terminated.

The locked image files 74 in Folder 1 of the confidential image folders 76 associated with the setting menu button 25 is released from the locked state together at one time. The locked image files 74 in Folder 1 of the confidential image folders 76 can be managed in a collective manner. The confirmation can be easy, so as to prevent failure in the confirming process. Note that the data managing in the motion picture pickup mode is similar to that in the still image pickup mode. No further description is made.

Despite the above embodiment in which the mode changer switch 21 is assigned as second operation unit, it is possible in another embodiment to assign the camera powering lens barrier 12 as second operation unit in place of the mode changer switch 21. When the lens barrier 12 is slid to the open position for turning on during depression of the first operation unit, then the access to the locked image files 74 in Folder 1 of the confidential image folders 76 is authorized, to interrupt the locking. When the lens barrier 12 is slid to the closed position for turning off during depression of the first operation unit, then the access to the locked image files 74 in Folder 1 of the confidential image folders 76 is inhibited, to lock the image files again.

In the above embodiment, reading of regular image files managed in the regular image folder is suppressed in unlocking the confidential image folders 76. However, it is possible to authorize reading of regular image files managed in the regular image folder even when the confidential image folders 76 is unlocked. Reproduction, deletion and transfer of the regular image files may be authorized.

In the above embodiment, unlocking of the locked image files 74 in the confidential image folders 76 associated with the first operation unit is at one time. However, it is possible to construct unlocking in an individual or separate manner between the confidential image folders 76.

In the above embodiment, the security information 72 is added to the image data 70 photographed in the digital still camera, and written to the memory card. The access to the image data 70 in the digital still camera is limited. However, it is possible to limit access of the locked image files 74 with the security information 72 in the memory card from one personal computer, a second digital still camera, or the like.

In the above embodiments, the operation units are the pushbuttons 21-28 or keys. However, operation units in the operation panel 18 can be externally operable structures other than the buttons 21-28, for example, a jog dial, levers, a touch panel, switches or buttons of a latch type, a ten-key keypad for inputting code numbers, and the like.

In the above embodiments, the menu pattern for the selection includes a row of regions with button names discernible from one another. However, specific reference information in a menu pattern in the LCD panel 16 for the operation units or buttons 21-28 may have forms that can be pointed with the pointing cursor 35 or the like. For example, button information may be words, initial letters as abbreviated signs, indicia, symbols, numerals or the like arranged in a predetermined pattern.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A digital camera, including plural operation units operable externally for determining a setting of items, and which writes image data obtained by photographing to a storage medium, said digital camera comprising:
a read/write controller for controlling reading from and writing to said storage medium with said image data; and
a controller, responsive if said shutter release button is depressed for photographing in shifting a first operation unit predetermined among said plural operation units, for causing said read/write controller to write security information in addition to said image data, said security information being associated with said first operation unit for access locking;
wherein in reading said image data from said storage medium, said controller controls said read/write controller to inhibit access to locked image data constituted by addition of said security information to said image data.

2. A digital camera as defined in claim 1, further comprising a display panel for displaying a menu pattern constituted by said items to be set by said plural operation units.

3. A digital camera as defined in claim 2, wherein said plural operation units include a second operation unit adapted for unlocking;
wherein when said second operation unit is shifted together with a shift of said first operation unit, said controller controls said read/write controller to authorize access to said image data irrespective of said addition of said security information in reading said image data from said storage medium.

4. A digital camera as defined in claim 3, wherein said first operation unit is at least one selected from said plural operation units by setting operation of manual handling before photographing.

5. A digital camera as defined in claim 4, wherein said setting operation is determination of selective designation of specific reference information by positioning of a pointing pattern, said specific reference information being indicated in said menu pattern, and discernibly associated with said plural operation units.

6. A digital camera as defined in claim 4, wherein if said first operation unit is shifted in shifting said second operation unit, said controller locks said image data being without addition of said security information, and protects said image data from access.

7. A digital camera as defined in claim 6, wherein if said first operation unit is shifted for a second time in shifting said second operation unit, said controller locks said locked image data again in addition of said security information for access locking.

8. A digital camera as defined in claim 7, wherein said second operation unit comprises a mode changer for setting a selected one of a photographing mode and a playback mode so as to indicate an image of said image data according thereto on said display panel.

9. A digital camera as defined in claim 8, wherein said second operation unit comprises a camera powering switch.

10. A digital camera as defined in claim 9, further comprising:
a taking lens for focusing object light;
a lens barrier, movable between closed and open positions in front of said taking lens, for covering said taking lens when in said closed position, and for causing said taking lens to emerge when in said open position;
wherein said camera powering switch turns on upon movement of said lens barrier to said open position.

11. A digital camera as defined in claim 3, wherein at least a confidential image folder and a regular image folder are used in said controller, said confidential image folder is assigned to said locked image data in addition of said security information, said regular image folder is assigned to said image data being without addition of said security information.

12. A digital camera as defined in claim 11, wherein said confidential image folder is defined in association with determination of said first operation unit.

13. A digital camera as defined in claim 1, wherein said image data is inhibited from being transferred, copied or deleted by protection from said access.

14. An image data processing method of image data processing in a digital camera operable by setting a selected one of a photographing mode and a playback mode, said photographing mode being adapted to photographing an image upon depressing a shutter release button to write image data of said image to a storage medium, said playback mode being adapted to displaying an image on a display panel by reading image data from said storage medium, said image data processing method comprising steps of:
while said photographing mode is set, outputting security information for access locking in addition to said image data if said shutter release button is depressed in shifting a first operation unit operable externally, to write said security information to said storage medium;
while said playback mode is set, checking whether said security information is added to said image data;
if said security information is not found added, authorizing access to said image data, wherein if said security information is found added, said image data is locked by determining said image data as locked image data, for protection of said locked image data from an unauthorized access.

15. An image data processing method as defined in claim 14, wherein said first operation unit is at least one selected from said plural operation units operable externally for determining a setting of items;
further comprising a step of displaying a menu pattern constituted by plural items to be set by said plural operation units.

16. An image data processing method as defined in claim 15, wherein said plural operation units include a second operation unit, being different from said first operation unit, and adapted for unlocking;
if said first operation unit is shifted in shifting said second operation unit, said access locking is interrupted, to authorize access to said locked image data irrespective of addition of said security information.
